(19) United States
(12) Patent Application Publication
(10) Pub. No.: US 2025/0189837 A1
(43) Pub. Date: Jun. 12, 2025

(54) VEHICLE DIMMING MODULE AND USE METHOD THEREOF

(71) Applicant: Kinpo Electronics, Inc., New Taipei City (TW)

(72) Inventors: Yu Chi Chen, New Taipei City (TW); Hsien Chung Chen, New Taipei City (TW)

(73) Assignee: Kinpo Electronics, Inc., New Taipei City (TW)

(21) Appl. No.: 18/426,361

(22) Filed: Jan. 30, 2024

(30) Foreign Application Priority Data
Dec. 11, 2023 (TW) 112148122

(51) Int. Cl. G02F 1/133; B60J 3/04; G02F 1/163

(52) U.S. Cl. CPC G02F 1/13312; G02F 1/163; B60J 3/04

(57) ABSTRACT

A vehicle dimming module including a first camera element, a first dimming element and a control element is provided. The first camera element is adapted to capture an appearance image of a user. The first dimming element is adapted to generate a first pattern. The control element is electrically connected to the first camera element and the first dimming element. The control element provides initial state signals and changing state signals based on the appearance image. The control element determines a viewing area on the first dimming element based on the initial state signal and drives the first dimming element to generate the first pattern in the viewing area, and the control element controls the first dimming element according to the change state signal to adjust the grayscale value and/or the transmittance of the first pattern.

### CROSS-REFERENCE TO RELATED APPLICATION

This application claims the priority benefit of Taiwan application serial no. 112148122, filed on Dec. 11, 2023. The entirety of each of the above-mentioned patent applications is hereby incorporated by reference herein and made a part of this specification.

### TECHNICAL FIELD

The disclosure relates to a vehicle optical device, and in particular to a vehicle dimming module and a method of using the same.

### BACKGROUND

If the sun or the light from the headlights of an oncoming car enters the driver's field of vision while the car is moving, the driver can only turn his head to dodge or use the visor. These actions cannot respond in time and may cause driving safety problems. Therefore, how to reduce the driver's avoidance movements of turning the head and focus more on the road conditions in front of the car, and improve driving safety, is one of the goals of this field.

### SUMMARY

The disclosure provides a vehicle dimming module and a use method thereof, which can instantly adjust the visual effects of driving vision and improve driving safety.

This disclosure provides a vehicle dimming module, including a first camera element, a first dimming element and a control element. The first camera element is adapted to capture an appearance image of a driver. The first dimming element is adapted to produce a first pattern. The control element is electrically connected to the first camera element and the first dimming element. The control element provides an initial state signal and a change state signal based on the appearance image. The control element determines a viewing area on the first dimming element based on the initial state signal and drives the first dimming element to generate the first pattern on the viewing area, and the control element controls the first dimming element to adjust the grayscale value and/or the transmittance of the first pattern according to the change state signal.

In an embodiment of the present disclosure, the first pattern is a grayscale pattern, and its transmittance is greater than or equal to 0% and less than or equal to 100%.

In an embodiment of the present disclosure, the initial state signal includes a height of the eyes of the driver.

In an embodiment of the present disclosure, the change state signal includes changes of an eye state, changes of a sitting posture and/or changes of a gesture state of the driver.

In an embodiment of the present disclosure, the vehicle dimming module according to claim further comprising a second camera element, electrically connected to the control element. The second camera element is adapted to capture the light source distribution of the external environment to obtain an ambient light signal. The control element determines a light source area on the first dimming element based on the ambient light signal and drives the first dimming element to generate a second pattern on the light source area.

In an embodiment of the present disclosure, the second pattern is a grayscale pattern, and its transmittance is greater than or equal to 0% and less than or equal to 100%.

In an embodiment of the present disclosure, the grayscale value of the second pattern is smaller than the grayscale value of the first pattern.

In an embodiment of the present disclosure, a transmittance of the second pattern is greater than a transmittance of the first pattern.

In an embodiment of the present disclosure, the grayscale value and a transmittance of an overlapping area of the second pattern that overlaps the first pattern are the same as a grayscale value and a transmittance of the second pattern.

In an embodiment of the present disclosure, the second camera element is also adapted to capture the changes of the light source distribution of the external environment to obtain an ambient light change signal, and the control element controls the first dimming element to adjust a position of the light source area and a grayscale value and/or a transmittance of the second pattern according to the ambient light change signal.

The disclosure also provides a use method of the vehicle dimming module, including a step of capturing the driving appearance image; a step of providing an initial state signal according to the appearance image; a step of determining a viewing area on a first dimming element according to the initial state signal; a step of driving the first dimming element to produce a first pattern in the viewing area; a step of providing a change state signal according to the appearance image; and a step of adjusting a grayscale value and/or a transmittance of the first pattern according to the change state signal.

In an embodiment of the present disclosure, the step of determining the viewing area on the first dimming element according to the initial state signal further comprising: a step of determining a height of the viewing area on the first dimming element according to a height of eyes of the appearance image.

In an embodiment of the present disclosure, the step of adjusting the grayscale value and/or the transmittance of the first pattern according to the change state signal further comprising: a step of when the eyes of the driver become smaller, reduce the grayscale value of the first pattern and/or increase the transmittance of the first pattern; and a step of when the eyes of the driver become larger, increase the grayscale value of the first pattern and/or decrease the transmittance of the first pattern.

In an embodiment of the present disclosure, the step of adjusting the grayscale value and/or the transmittance of the first pattern according to the change state signal further comprising: when the sitting posture of the driver moves forward, increase the grayscale value of the first pattern and/or decrease the transmittance of the first pattern.

In an embodiment of the present disclosure, the step of adjusting the grayscale value and/or the transmittance of the first pattern according to the change state signal further comprising: when the hand of the driver is raised and blocking the view of the eyes, reduce the grayscale value of the first pattern and/or increase the transmittance of the first pattern.

In an embodiment of the present disclosure, the step of the use method of the vehicle dimming module further comprising: a step of capturing a light source distribution of an external environment to obtain an ambient light signal; a step of determining a light source area on the first dimming element according to the ambient light signal; and a step of driving the first dimming element to produce a second pattern in the light source area.

Based on the above, in the vehicle dimming module and the use method thereof of the present disclosure, the vehicle dimming module includes a first camera element, a first dimming element and a control element. Wherein, the control element provides initial state signal and change state signal based on the appearance image captured by the first camera element, and determines the viewing area on the first dimming element based on the initial state signal, so that the first dimming element generates the first pattern in the viewing area. In addition, the control element also controls the first dimming element according to the change state signal to adjust the grayscale value and/or the transmittance of the first pattern. In this way, the brightness of the windshield of the driving vision can be adjusted without the need to use the visor or turning the head immediately, improving the optical effect of the driving vision and driving safety of the driver.

Several exemplary embodiments accompanied with figures are described in detail below to further describe the disclosure in details.

### BRIEF DESCRIPTION OF THE DRAWINGS

FIG. 1 is a schematic diagram of a vehicle dimming module applied to a vehicle according to an embodiment of the disclosure.

FIG. 2 is a schematic diagram of a driving appearance image captured by a camera element according to an embodiment of the disclosure.

FIG. 3 is a schematic diagram of a first dimming element according to an embodiment of the disclosure.

FIG. 4A to FIG. 4C are respectively schematic diagrams of an eyes state of the driver according to different embodiments of the disclosure.

FIG. 5A and FIG. 5B are respectively schematic diagrams of a sitting postures of the driver according to different embodiments of the disclosure.

FIG. 6A and FIG. 6B are respectively schematic diagrams of a gesture states of the driver from different viewing angles according to an embodiment of the disclosure.

FIG. 7 is a schematic diagram of a use method of a vehicle dimming module according to an embodiment of the disclosure.

### DETAILED DESCRIPTION OF DISCLOSURED EMBODIMENTS

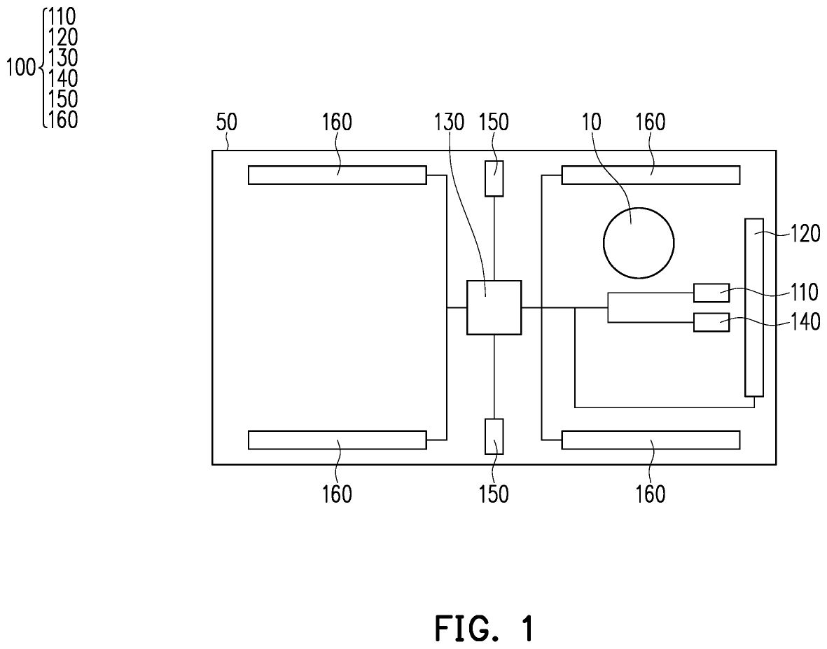

FIG. 1 is a schematic diagram of a vehicle dimming module applied to a vehicle according to an embodiment of the disclosure. Please refer to FIG. 1. This embodiment provides a vehicle dimming module 100, which can be applied to vehicles 50 and other types of vehicles. The vehicle dimming module 100 includes a first camera element 110, a first dimming element 120 and a control element 130. Wherein, the vehicle dimming module 100 is used to adjust the transmittance of the vehicle window according to the status of a drive 10 to improve the driving vision optical effect and driving safety of the driver 10.

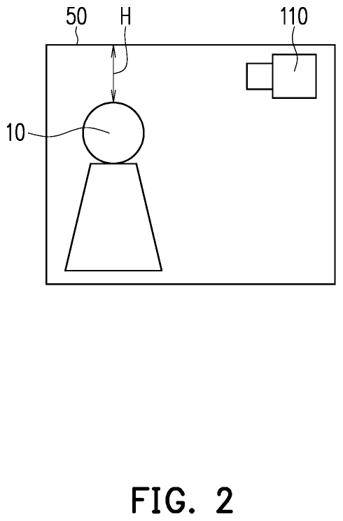

FIG. 2 is a schematic diagram of a driving appearance image captured by a camera element according to an embodiment of the disclosure. Please refer to FIG. 1 and FIG. 2. The first camera element 110 is adapted to capture the appearance image of the driver 10, for example, a height of eyes of the driver 10. For example, the appearance image can be captured by the first camera element 110 to calculate the distance H from driving 10 to the top of the vehicle 50, so that the height position of viewing area B1 can be determined later on the first dimming element 120 based on the height of the eyes of the appearance image. However, the present invention is not limited to this. Furthermore, the first camera element 110 can also capture and collect information such as the size of the eyes and the distance between the eyes and the window of the driver 10, but the present invention is not limited to this. The first camera element 110 can be installed inside the vehicle and close to the upper half of the windshield, for example, it can be installed on the rearview mirror inside the car. However, the present invention does not limit the type of the first camera element 110 and its installation method.

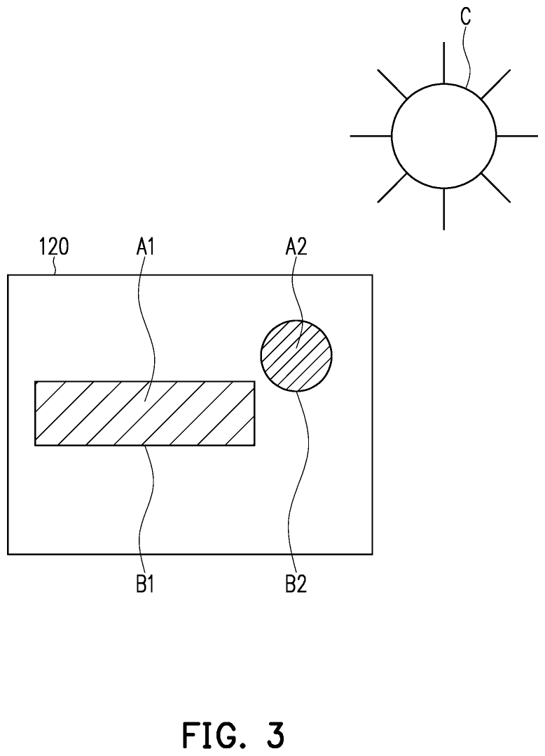

FIG. 3 is a schematic diagram of a first dimming element according to an embodiment of the disclosure. Please refer to FIG. 1 and FIG. 3. The first dimming element 120 is adapted to generate the first pattern A1. This first pattern A1 has a transmittance, so that the driver 10 can observe the first pattern A1 while observing the outside, thereby changing the visual effects when observing the outside. For example, the first dimming element 120 is a vehicle windshield formed of electrochromic glass, or a polymer-dispersed liquid crystal (PDLC) formed on the windshield. However, the present invention is not limited to this. In this embodiment, the first pattern A1 is, for example, a grayscale pattern, and its transmittance is greater than or equal to 0% and less than or equal to 100%.

The control element 130 is electrically connected to the first camera element 110 and the first dimming element 120. The control element 130 includes, for example, a central processing unit (CPU), or other programmable general-purpose or special-purpose microprocessor, digital signal processor (DSP), programmable chemical controller, application specific integrated circuit (ASIC) or other similar components or a combination of the above components, the invention is not limited thereto. The control element 130 provides an initial state signal based on the appearance image of the driver 10. After generating the initial state signal, the control element 130 determines a viewing area B1 on the first dimming element 120 according to the initial state signal and drives the first dimming element 120 to generate the first pattern A1 on the viewing area B1. For example, the viewing area B1 is a rectangular area in the main driving viewing direction. However, in different embodiments, the viewing area B1 can also be the entire windshield area. For another example, the first pattern A1 is a grayscale pattern with grayscale value (180, 180, 180) and transmittance 40%. In this way, the brightness of the windshield of the driving vision can be adjusted without the need to use the visor or turning the head immediately, improving the optical effect of the driving vision and driving safety of the driver 10. In a preferred embodiment, the vehicle dimming module 100 also includes a second camera element 140 electrically connected to the control element 130, adapted to capture the light source distribution of the external environment (external light source C as shown in FIG. 3) to obtain an ambient light signal. Therefore, the control element 130 can also determine a range of the viewing area B1 and/or the grayscale value and the transmittance of the first pattern A1 based on the ambient light signal. In other words, the range of viewing area B1 and the grayscale value and the transmittance of first pattern A1 can be determined by selecting at least one of the initial state signal and the ambient light signal according to different situations, the present invention is not limited thereto.

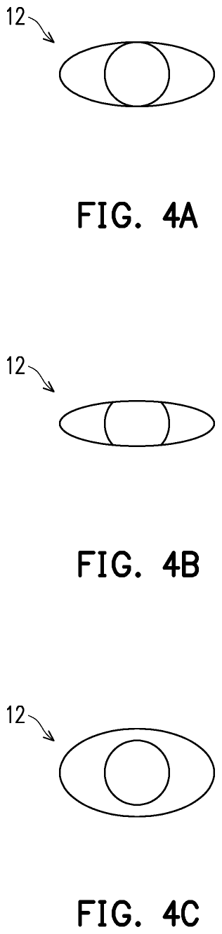

FIG. 4A to FIG. 4C are respectively schematic diagrams of an eyes state of the driver according to different embodiments of the disclosure. Please refer to FIG. 3 to FIG. 4C. In addition, after the first pattern A1 is generated, the control element 130 further provides a change state signal based on the appearance image of the driver 10. The change state signal includes, for example, changes of an eyes state, changes of a sitting posture, and/or changes of a gesture state of the driver 10, but the invention is not limited thereto. After generating the change state signal, the control element 130 controls the first dimming element 120 to adjust the grayscale value and/or the transmittance of the first pattern A1 according to the change state signal. In other words, the first pattern A1 can adjust the optical display effect according to the driving status to adapt to any driving situation, thereby increasing driving safety.

For example, the size of eyes 12 shown in FIG. 4A is the state during normal driving. When the eyes 12 of the driver 10 become smaller, as shown in FIG. 4B, it means that the color of the first dimming element 120 is too bright or the transparency is too low. The control element 130 will control the first dimming element 120 according to this change state signal to reduce the grayscale value of the first pattern A1 and/or increase the transmittance of the first pattern A1. For example, the first pattern A1 with a grayscale value of (180, 180, 180) and a transmittance of 40% is adjusted to a grayscale pattern with a grayscale value of (170, 170, 170) and a transmittance of 45%, but is not limited to this. When the eyes 12 of driver 10 become larger, as shown in FIG. 4C, it means that the color of the first dimming element 120 is too dark or the transparency is too high. The control element 130 will control the first dimming element 120 according to this change state signal to increase the grayscale value of the first pattern A1 and/or reduce the transmittance of the first pattern A1. For example, the first pattern A1 with a grayscale value of (180, 180, 180) and a transmittance of 40% is adjusted to a grayscale pattern with a grayscale value of (185, 185, 185) and a transmittance of 35%, but is not limited to this. In this way, the brightness of the windshield of the driving vision can be adjusted without the need to use the visor or turning the head immediately, improving the optical effect of the driving vision and driving safety of the driver 10.

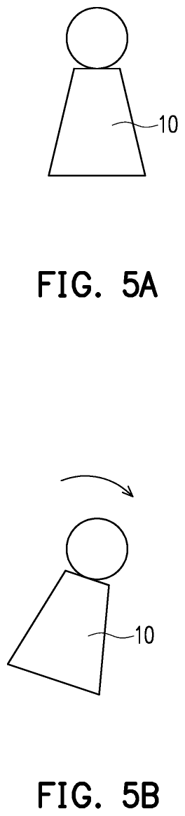

FIG. 5A and FIG. 5B are respectively schematic diagrams of a sitting postures of the driver according to different embodiments of the disclosure. Please refer to FIG. 3, FIG. 5A and FIG. 5B. FIG. 5A shows a sitting posture of a driver during normal driving. In another embodiment, when the sitting posture of the driver 10 changes forward, as shown in FIG. 5B, it means that the color of the first dimming element 120 is too dark or the transparency is too high. The control element 130 will control the first dimming element 120 according to this change state signal to increase the grayscale value of the first pattern A1 and/or reduce the transmittance of the first pattern A1. For example, the first pattern A1 with a grayscale value of (180, 180, 180) and a transmittance of 40% is adjusted to a grayscale pattern with a grayscale value of (185, 185, 185) and a transmittance of 35%, but is not limited to this. In this way, the brightness of the windshield of the driving vision can be adjusted without the need to use the visor or turning the head immediately, improving the optical effect of the driving vision and driving safety of the driver 10.

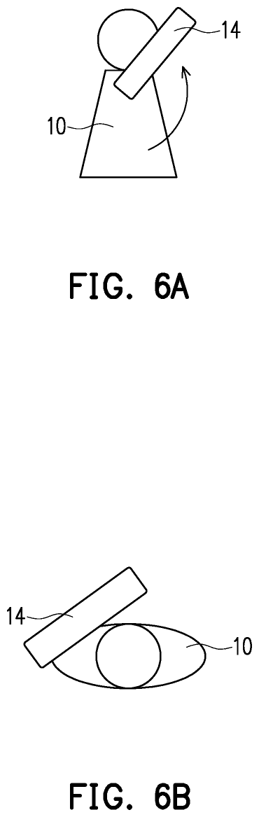

FIG. 6A and FIG. 6B are respectively schematic diagrams of a gesture states of the driver from different viewing angles according to an embodiment of the disclosure. Please refer to FIG. 3, FIG. 6A and FIG. 6B. FIG. 6A shows a hand state of a driver during normal driving. In another embodiment, when the driver 10 raises the hand 14 due to changes in the visual field light source, as shown in FIG. 6B, it means that the color of the first dimming element 120 is too bright or the transparency is too low. The control element 130 will control the first dimming element 120 according to this change state signal to reduce the grayscale value of the first pattern A1 and/or increase the transmittance of the first pattern A1. For example, the first pattern A1 with a grayscale value of (180, 180, 180) and a transmittance of 40% is adjusted to a grayscale pattern with a grayscale value of (170, 170, 170) and a transmittance of 45%, but is not limited to this. In this way, the brightness of the windshield of the driving vision can be adjusted instantly without the need to use the visor or turn the head immediately, improving the optical effect of the driving vision and driving safety of the driver 10.

Please refer to FIG. 1 and FIG. 3. In this embodiment, the control element 130 can also determine a light source area B2 on the first dimming element 120 based on an ambient light signal obtained by capturing a light source distribution (external light source C shown in FIG. 3) of the external environment based on the second camera element 140 and drive the first dimming element 120 to light source area B2 produces second pattern A2. Wherein the detailed implementation method of capturing the light source distribution of the external environment and deducing the corresponding position of the light source area B2 on the first dimming element 120 through calculation can obtain sufficient teachings, suggestions and implementation instructions can be obtained from common knowledge in the technical field, and therefore will not be described again.

Similar to first pattern A1, the second pattern A2 is also a grayscale pattern, and the transmittance is greater than or equal to 0% and less than or equal to 100%. Compared with the first pattern A1, the grayscale value of the second pattern A2 is smaller than the grayscale value of the first pattern A1, and the transmittance of the second pattern A2 is greater than the transmittance of the first pattern A1. For example, the second pattern A2 is a grayscale pattern with grayscale value (90, 90, 90) and transmittance 80%. In this way, the visual effects affected by the external light source C can be effectively reduced, and the driving visual effects and driving safety of the driver 10 can be improved. It is worth mentioning that, in another embodiment, if the light source area B2 overlaps the viewing area B1, the grayscale value and the transmittance of the overlapping area of the second pattern A2 overlapping the first pattern A1 will be the same as the grayscale value and the transmittance of the second pattern A2.

On the other hand, similar to the first camera element 110, the second camera element 140 is also adapted to capture changes of the light source distribution of the external environment to obtain an ambient light change signal. The control element 130 will control the first dimming element 120 to adjust the position of the light source area B2 and the grayscale value and/or the transmittance of the second pattern A2 according to the ambient light change signal.

Please continue to refer to FIG. 1 and FIG. 3. The vehicle dimming module 100 also includes at least one third camera element 150 and at least one second dimming element 160, which are electrically connected to the control element 130. For example, in this embodiment, the number of the third camera element 150 is, for example, two, which are respectively arranged on the left and right sides of the vehicle 50, and the number of the second dimming element 160 is, for example, two, which are respectively arranged on the window glass located on both sides of the vehicle 50. Similar to the second camera element 140, the two third camera elements 150 can capture images toward the left and right outer sides of the vehicle 50 respectively, and then capture the light source distribution of the external environment to obtain the ambient light signal, and the first camera element 110 is also adapted to capture appearance images of other passengers in the car. Moreover, the control element 130 is used to provide an initial state signal and a change state signal based on the appearance images of other passengers in the car.

Therefore, the control element 130 can determine a light source area on the corresponding second dimming element 160 according to the initial state signals of different passengers in the car and drive the second dimming element 160 to generate a grayscale pattern in the light source area. And similar to the content introduced above, the control element 130 can respectively control the second dimming elements 160 according to the change state signals of different passengers in the car to adjust the grayscale value and/or the transmittance of these grayscale patterns. In this way, the visual effects of the window glass observed by other passengers can be adjusted, thereby improving the ride quality of the passengers.

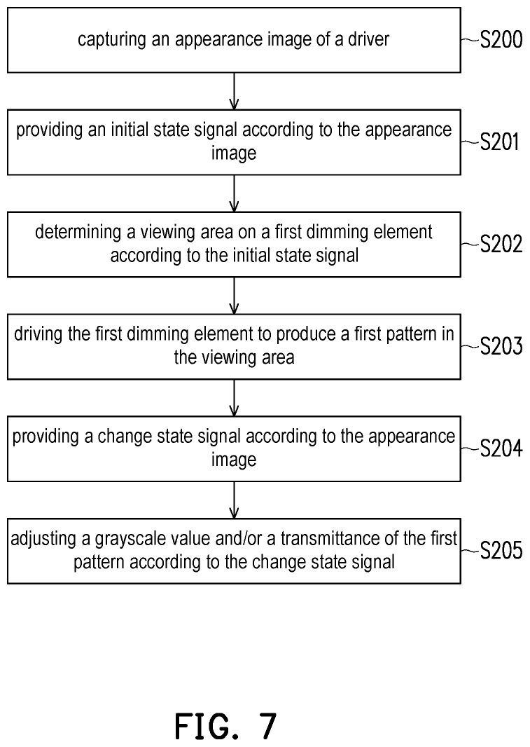

FIG. 7 is a schematic diagram of a use method of a vehicle dimming module according to an embodiment of the disclosure. Please refer to FIG. 1, FIG. 3 and FIG. 7. This embodiment provides a use method of a vehicle dimming module, which can be applied to at least the vehicle dimming module 100 shown in FIG. 1 and FIG. 3, so the following description takes this as an example. In this embodiment, first, step S200 is executed to capture an appearance image of a driver 10. Specifically, the first camera element 110 of the vehicle dimming module 100 is used to capture the image of the driver 10 to obtain the appearance image of the driver 10.

Next, step S201 is executed to provide an initial state signal based on the appearance image. Specifically, the control element 130 is used to generate the initial state signal based on the appearance image of the driver 10. Next, step S202 is executed to determine a viewing area B1 on the first dimming element 120 according to the initial state signal of the driver 10. Specifically, the control element 130 is used to make the first dimming element 120 determine the position and range of the viewing area B1 according to the initial state signal of the driver 10.

Next, step S203 is executed to drive the first dimming element 120 to produce a first pattern A1 in the viewing area B1. Specifically, the control element 130 is used to control the first dimming element 120 to generate the first pattern A1 with a grayscale effect. Then, step S204 is executed to provide a change state signal based on the appearance image. Specifically, similar to the step S201, the control element 130 is used to generate a change state signal based on the appearance image of the driver 10. Finally, step S205 is executed to adjust a grayscale value and/or a transmittance of the first pattern A1 according to the change state signal. Specifically, the control element 130 is used to control the first dimming element 120 to change the grayscale value and/or the transmittance of the first pattern A1. In this way, the brightness of the windshield of the driving vision can be adjusted without the need to use the visor or turning the head immediately, improving the optical effect of the driving vision and driving safety of the driver.

In summary, in the vehicle dimming module and the use method of the vehicle dimming module of the disclosure, the vehicle dimming module includes first camera element, first dimming element and control element. Wherein the control element provides an initial state signal and a change state signal based on an appearance image captured by the first camera element, and determines a viewing area on the first dimming element based on the initial state signal, so that the first dimming element generates a first pattern in the viewing area. In addition, the control element also controls the first dimming element according to the change state signal to adjust the grayscale value and/or the transmittance of the first pattern. In this way, the brightness of the windshield of the driving vision can be adjusted without the need to use the visor or turning the head immediately, improving the optical effect of the driving vision and driving safety of the driver.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A vehicle dimming module, comprising:
a first camera element, adapted to capture an appearance image of a driver;
a first dimming element, adapted to produce a first pattern; and
a control element, electrically connected to the first camera element and the first dimming element, the control element provides an initial state signal and a change state signal based on the appearance image, the control element determines a viewing area on the first dimming element based on the initial state signal and drives the first dimming element to generate the first pattern on the viewing area, and the control element controls the first dimming element to adjust the grayscale value and/or transmittance of the first pattern according to the change state signal.

2. The vehicle dimming module according to claim 1, wherein the first pattern is a grayscale pattern, and its transmittance is greater than or equal to 0% and less than or equal to 100%.

3. The vehicle dimming module according to claim 1, wherein the initial state signal includes a height of eyes of the driver.

4. The vehicle dimming module according to claim 1, wherein the change state signal includes changes of an eyes state, changes of a sitting posture, and/or changes of a gesture state of the driver.

5. The vehicle dimming module according to claim 1, further comprising:
a second camera element, electrically connected to the control element, the second camera element is adapted to capture the light source distribution of the external environment to obtain an ambient light signal, the control element determines a light source area on the first dimming element based on the ambient light signal and drives the first dimming element to generate a second pattern on the light source area.

6. The vehicle dimming module according to claim 5, wherein the second pattern is a grayscale pattern, and its transmittance is greater than or equal to 0% and less than or equal to 100%.

7. The vehicle dimming module according to claim 5, wherein the grayscale value of the second pattern is smaller than the grayscale value of the first pattern.

8. The vehicle dimming module according to claim 5, wherein a transmittance of the second pattern is greater than a transmittance of the first pattern.

9. The vehicle dimming module according to claim 5, wherein the grayscale value and a transmittance of an overlapping area of the second pattern that overlaps the first pattern are the same as a grayscale value and a transmittance of the second pattern.

10. The vehicle dimming module according to claim 5, wherein the second camera element is also adapted to capture the changes of the light source distribution of the external environment to obtain an ambient light change signal, and the control element controls the first dimming element to adjust a position of the light source area and a grayscale value and/or a transmittance of the second pattern according to the ambient light change signal.

11. A use method of a vehicle dimming module, comprising:
capturing an appearance image of a driver;
providing an initial state signal according to the appearance image;
determining a viewing area on a first dimming element according to the initial state signal;
driving the first dimming element to produce a first pattern in the viewing area;
providing a change state signal according to the appearance image; and
adjusting a grayscale value and/or a transmittance of the first pattern according to the change state signal.

12. The use method of the vehicle dimming module according to claim 11, wherein the step of determining the viewing area on the first dimming element according to the initial state signal further comprising:
determining a height of the viewing area on the first dimming element according to a height of eyes of the appearance image.

13. The use method of the vehicle dimming module according to claim 11, wherein the step of adjusting the grayscale value and/or the transmittance of the first pattern according to the change state signal further comprising:
when the eyes of the driver become smaller, reduce the grayscale value of the first pattern and/or increase the transmittance of the first pattern; and
when the eyes of the driver become larger, increase the grayscale value of the first pattern and/or decrease the transmittance of the first pattern.

14. The use method of the vehicle dimming module according to claim 11, wherein the step of adjusting the grayscale value and/or the transmittance of the first pattern according to the change state signal further comprising:
when the sitting posture of the driver moves forward, increase the grayscale value of the first pattern and/or decrease the transmittance of the first pattern.

15. The use method of the vehicle dimming module according to claim 11, wherein the step of adjusting the grayscale value and/or the transmittance of the first pattern according to the change state signal further comprising:
when the hand of the driver is raised and blocking the view of the eyes, reduce the grayscale value of the first pattern and/or increase the transmittance of the first pattern.

16. The use method of the vehicle dimming module according to claim 11, further comprising:
capturing a light source distribution of an external environment to obtain an ambient light signal;
determining a light source area on the first dimming element according to the ambient light signal; and
driving the first dimming element to produce a second pattern in the light source area.
